(19) United States
(12) Patent Application Publication
(10) Pub. No.: US 2004/0056387 A1
(43) Pub. Date: Mar. 25, 2004

(54) Method for molding closed shapes

(76) Inventor: Anthony Italo Provitola, DeLand, FL (US)

Correspondence Address: Anthony I. Provitola, Post Office Box 2855, DeLand, FL, 32721-2855, US

(21) Appl. No.: 10/253,622

(22) Filed: Sep. 24, 2002

(51) Int. Cl. B29C 45/00

(52) U.S. Cl. 264/442; 264/313; 164/465

(57) ABSTRACT

The present invention is a method for one piece molding of closed shapes which have interior surface features. The method involves the dissociation of the mold for the interior surface of the closed shape which is removed through an opening in the closed shape upon dissociation.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO MICROFICHE APPENDIX

Not Applicable

### BACKGROUND OF THE INVENTION

The process of the molding objects generally requires that the object molded be separated from the mold after the fluent stock, placed in the shaping cavity of the mold by methods such as injection or pouring, has solidified to form the object. However, when the object to be molded has a closed shape, i.e. an interior space whose shape is confined by the object to be molded, and the interior of the object has surfaces which must also be molded, the molding process must be modified to separate the confined part of the mold from the object molded. The molding of such shapes is usually accomplished by molding of the object in parts which can be joined or fused to form the closed shape, as in the case of glass bottles; or by disassembling the part of the mold which is confined and removing it from the closed shape through one or more openings in the confining part of the object molded, such disassembled part being then used again in the mold after reassembly. The necessity for disassembly and reassembly of the part of the mold that is confined frequently requires such a part to have a complex structure and constituent sub-parts; and thus automation of the molding process for high production becomes mechanically complex and less reliable. The present invention advances the art of molding to allow the molding of closed shapes with moldable features on the interior surfaces of the shape which would otherwise confine part of the mold, without the necessity for disassembly and reassembly of a confined mold-part.

The prior art that this invention builds upon is generally in the field of molding, U.S. Class 425, particularly sub-classes 436 (shaping surface with means to release or remove product), 440 (bending, reshaping or distortion of a mold surface to break the bond with the mold surface), 441 (motion of a portion of the shaping surface relative to the remainder thereof to release the molded article); and more particularly sub-class 542, injection molding, and sub-classes 549 (a shaping cavity structure formed of separable segments with motion that changes the cavity forming relationship), and 595 (a dynamic means for securing the separable segments of a cavity structure together).

### BRIEF SUMMARY OF THE INVENTION

The present invention is a method for molding objects which have a closed shape with interior surfaces which also must be molded. The method may be applied to all types of molding, including injection molding of small objects.

The method is carried out with a mold with one or more parts for the exterior surfaces of the object and one or more parts for the interior surfaces of the object, the mold-parts for the interior surfaces being composed of a material which is in a solid state during the molding process, but is removable by dissociation, including chemical, thermal, electromagnetic, or other physical means through an opening in the object of sufficient size to allow the atoms, molecules, or particles of the mold-part as dissociated to pass through.

The method includes the construction of a mold for the object comprised of interior and exterior mold-parts having impressions of the corresponding sides of the object, with the mold-part for shaping the interior of the object being dissociable; assembly of the mold to form a shaping cavity; introduction into the shaping cavity of fluent stock, i.e. flowing material to be molded; causing or permitting the setting or hardening of the stock in the desired shape; removing the exterior and any other unconfined mold-parts; and the separation of the object from the mold by the removal of the confined interior mold-parts by dissociation of the mold material.

An example of the use of the method also described is the production of toroidal frameworks of toroidal elements in a metal utilizing metal injection molding, in a polymer such as nylon, in a ceramic, and in a glass.

### BRIEF DESCRIPTION OF THE DRAWINGS

FIG. 1 is a perspective view of a framework of toroidal elements.

FIG. 2 is a perspective view of an exterior mold-subpart for the framework of toroidal elements shown in FIG. 1.

FIG. 3 is a perspective schematic transparent view of upper and lower exterior mold-subparts joined to form the complete exterior mold-part for the framework of toroidal elements shown in FIG. 1.

FIG. 4 is a perspective view of a complete interior mold-part for the framework of toroidal elements shown in FIG. 1.

FIG. 5 is a perspective view of the complete interior mold-part shown in FIG. 4 confined by the framework of toroidal elements shown in FIG. 1.

FIG. 6 is a perspective view of a lower exterior mold-subpart shown in FIG. 2 holding a molded framework of toroidal elements shown in FIG. 1 which is confining the interior mold-part shown in FIG. 4.

FIG. 7 is a perspective view of the exterior mold-subpart shown in FIG. 2 assembled with the interior mold-part shown in FIG. 3.

FIG. 8 is an exploded perspective view of a complete interior mold-part showing its fabrication in two hollow sub-parts.

### DETAILED DESCRIPTION OF THE INVENTION

The present invention is a method for molding objects which have a closed shape, i.e. a shape having an interior space which is confined by the shape itself, the interior of the surfaces of which must also be molded. The method may be applied to all types of molding, but is particularly useful for injection molding of small objects with a closed shape as described.

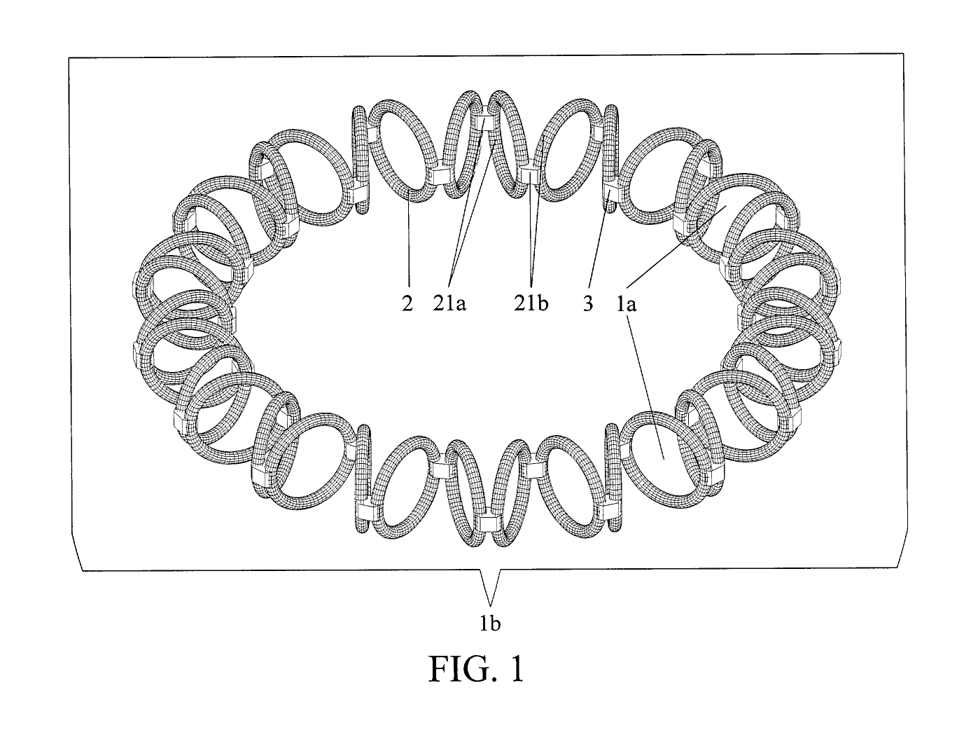

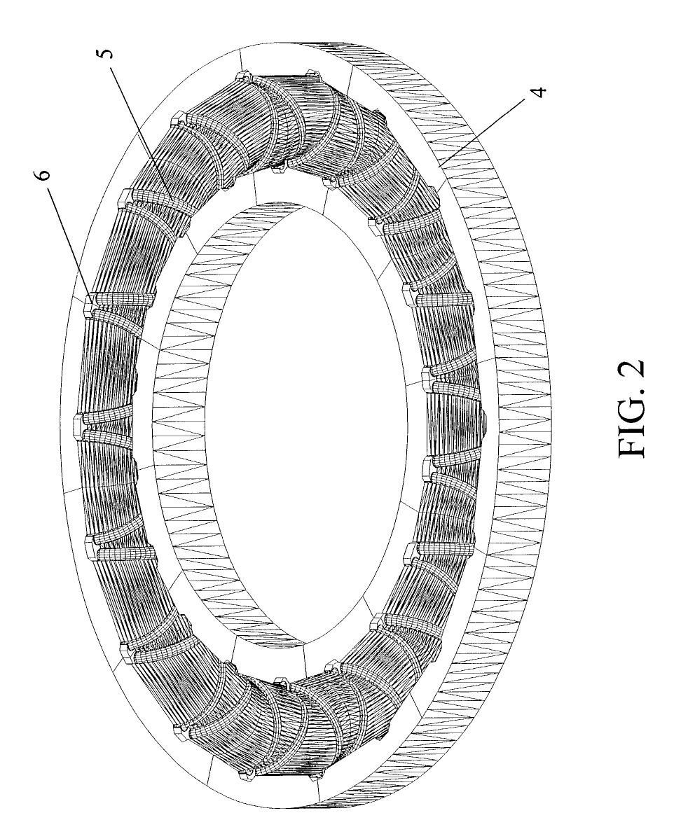

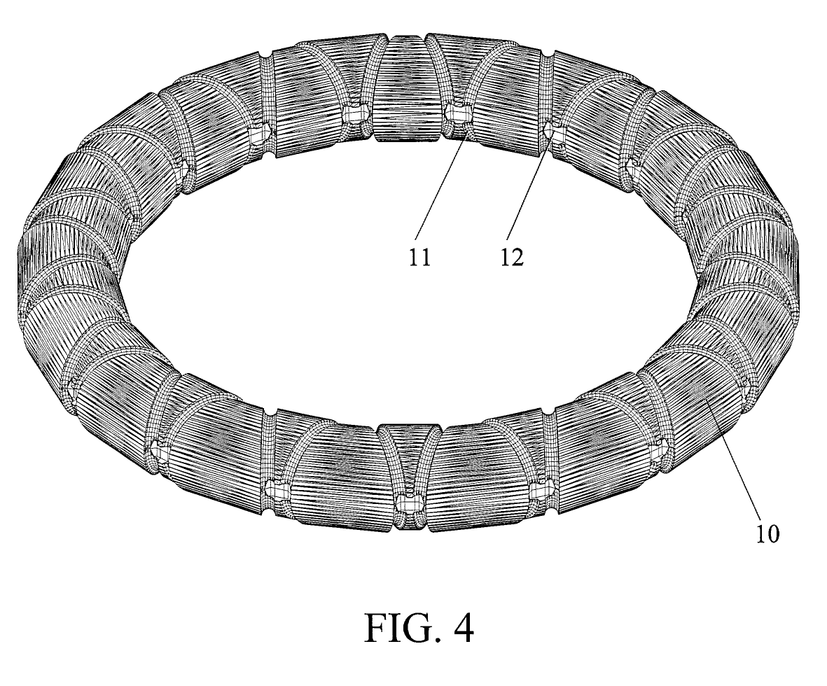

The method is carried out with a mold with one or more parts for the exterior surfaces of the object and one or more parts for the interior surfaces of the object. As used in this application, and as indicated in FIG. 1, the interior surface 21a of an object refers to the surface of the object 2 and 3 which is directly exposed to the interior space 1a of the object. The interior space 1a of an object shall be taken to mean the space that is bounded by the object, and shall include space that is within a framework, or within a surface defined by a framework, or within a framework and a surface defined by the framework, as exemplified in FIG. 1. The method is particularly disclosed through drawings of frameworks of connected toroidal elements as the object to be molded, as shown in FIG. 1, with toroidal elements 2 and connectors 3, in addition to the general disclosure which applies to the molding of all objects which have a closed shape. As previously mentioned, the interior space 1a with respect to the framework is shown in FIG. 1. The exterior space of the object 1b is the space exterior to the object and within which the entire object (including its interior space) is located. As used in this application, and as shown in FIG. 1, the exterior surface 21b of an object refers to the surface of the object which is directly exposed to the space exterior to the object 1b. The exterior space 1b of an object shall also be taken to mean the space by which the object is bounded, and shall include space that is outside of a framework, or outside of a surface defined by a framework, or outside of a framework and a surface defined by the framework. A surface is directly exposed to and bounded by a space, interior or exterior, where the space is not occupied by the material of the object and is contiguous with the object. The mold-part that forms the interior surfaces 11 and 12, shown in FIG. 4 for the framework shown in FIG. 1, is composed of a material which is in a solid state during molding of the fluent stock, but dissociable after formation of the object to be molded. The term dissociable as used herein shall include, chemically dissociable, vaporizable, liquefiable, pulverizable, soluble, thermolyzable, or otherwise reducible from the solid state in a way that will allow for removal from an object after the formation of the object, such as the framework shown in FIG. 1. The removal of the mold for the interior surfaces after its dissociation takes place through an opening in the object, either temporary or permanent, of sufficient size to allow the atoms, molecules, or particles of the mold as dissociated to pass through, such as the spaces between the toroidal elements 2 that comprise the framework shown in FIG. 1. The exterior mold-part 4 shown in FIG. 2 which shapes the exterior surfaces of the framework 5 and 6 may be similarly dissociable, or be more permanent and reusable.

The objects of the present invention are:

1. To provide a method for molding objects which have a closed shape the interior surfaces of which have moldable features.

2. To provide a method for molding objects which permits separation from the mold by the dissociation of the mold material.

3. To provide a method for the molding in a single piece of frameworks of connected toroidal elements.

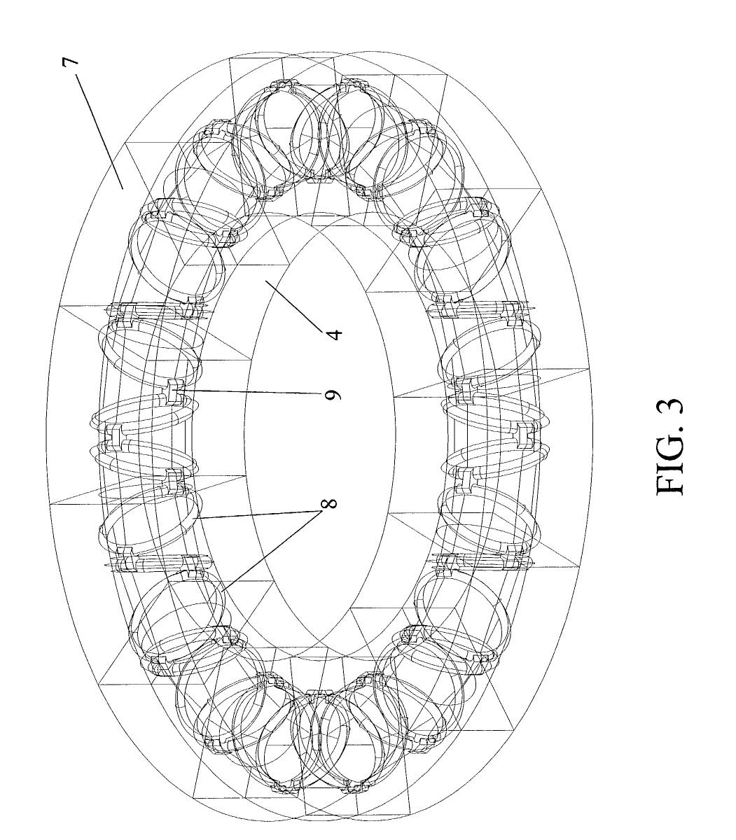

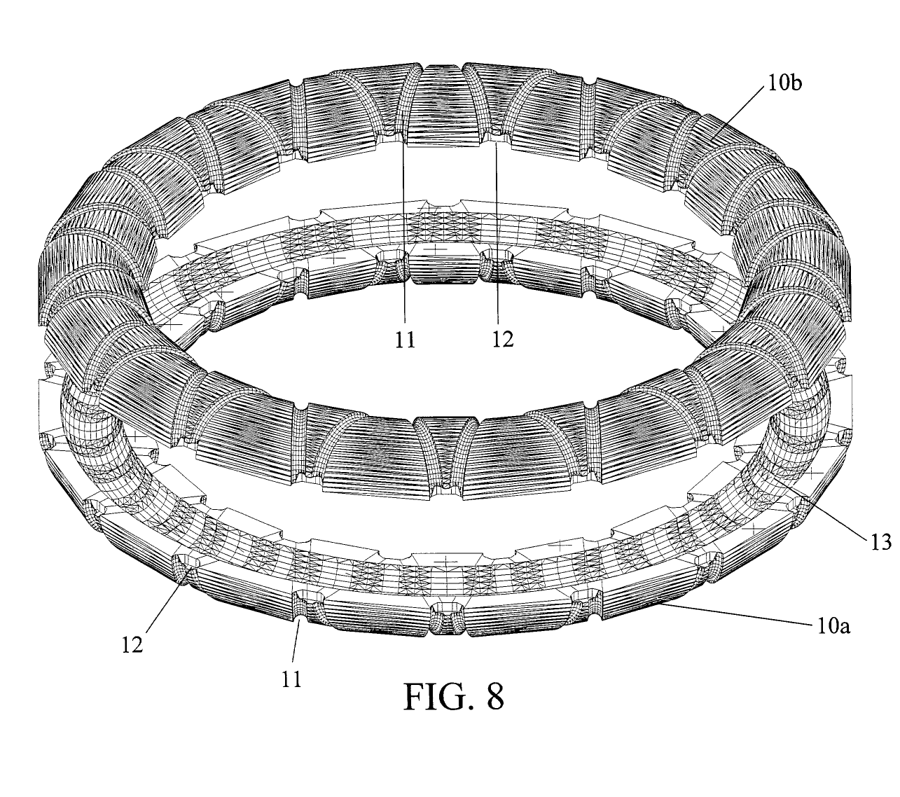

The first step in the method is the construction of a mold for the object in two or more mold-parts, at least one interior mold-part 10, such as shown in FIG. 4, and at least one exterior mold-part 4 and 7, such as shown in FIGS. 2 and 3. Such interior and exterior mold-parts may be comprised of mold-subparts 4, 7, 10a, and 10b, as shown in FIGS. 3 and 8, which when assembled form a complete interior 10 or exterior 4 and 7 mold-part. Interior 10 and exterior 4 and 7 mold-parts have surfaces 5, 6, 11, and 12 which are an impression, i.e. a concavity in a surface which bounds a region of space, that form the shaping cavity, the shape of which is that of the object they will together mold. An interior mold-part 10 may form all or part of one or more of the interior surfaces of the object to be molded 11 and 12, and an exterior mold-part may forms all or part of one or more of the exterior surfaces of the object to be molded 5 and 6. Each interior mold-part 10 is comprised of a material that differs from the material being used to mold the object, so that the effect of an environment to which each of the materials are subjected can be regulated to be different on both materials: the effect of such regulation on the object having a range from being relatively unaffected to causing it to proceed to its desired state of structural integrity, where the effect of the same regulation on an interior mold-part 10 will be to have it dissociate sufficiently for removal from the interior space of the object through one or more openings in the object. Exterior mold-parts 4 and 7 may be stable or dissociable, depending on the shape of the exterior surface 21b of the object being molded. If the shape of the exterior surface 21b is such that the corresponding exterior mold-parts 4 and 7 will not trap any part of the of the object being molded, the mold-part may be made of a solid material that is not dissociable. Because the method includes a step requiring the dissociation of an interior mold-part 10, one instance of the set of dissociable mold-parts for a complete mold is necessary to form each instance of the molded object. Such mold-parts must therefore be produced in numbers sufficient for the purpose, and may themselves be molded.

The second step in the method is the assembly of the mold which results in the enclosure of the interior mold-part 10 within in the corresponding exterior mold-parts 4 and 7, all mold-parts 4, 7, and 10 may be keyed together to maintain their position with respect to one another. The assembled mold contains a shaping cavity which is in the shape of the object to be molded, and incorporates ports for the introduction of the fluent stock to be molded into the object, usually a liquid or a flowing powder. A partially assembled mold for a toroidal framework of toroidal elements is shown in FIG. 7, comprised of an lower exterior mold-part, as shown in FIG. 2 and an interior mold-part, as shown in FIG. 4, in which the shaping cavity is indicated as bounded by the shaping surfaces for the toroidal elements 5 and 11 and the shaping surfaces for the connectors 6 and 12, but without the injection ports.

The third step in the method is the introduction into the shaping cavity of the fluent stock to be molded, either by pouring or by injection, the latter being more suitable for complex shapes with small dimensions.

The fourth step of the method is to cause or allow setting or hardening of the fluent stock placed in the shaping cavity to the point where it will maintain the shape into which it was molded with the mold removed. Such setting or hardening may be passive, as by solidification with cooling by absorption of heat from the flowing material by the mold, or active, as by curing certain types of polymer material in the mold with the exposure to ultraviolet light or other radiation.

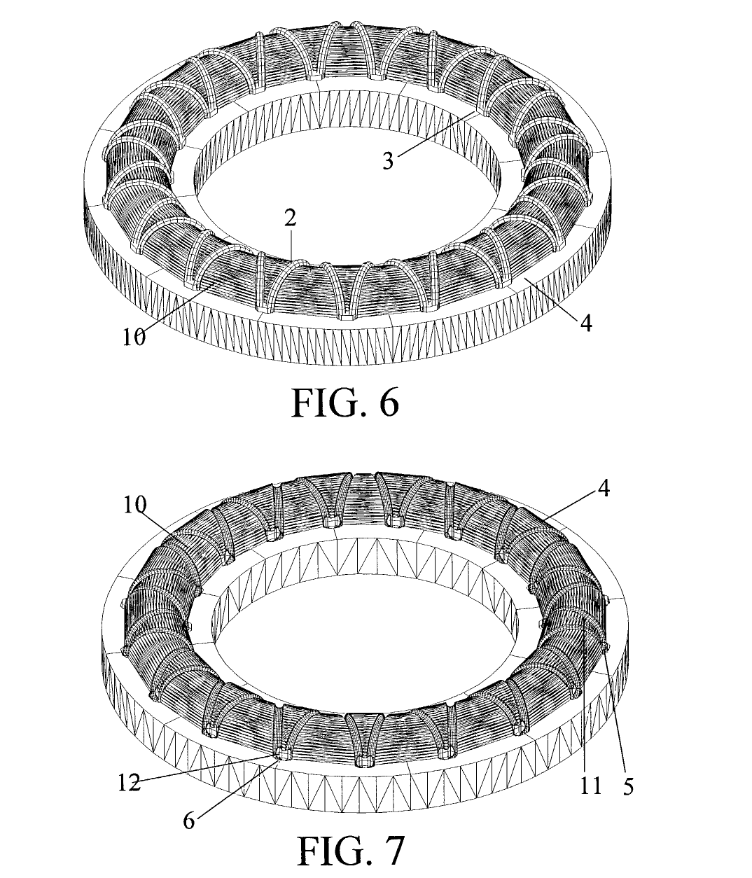

An example of a mold with an object to be molded contained within the lower part of an exterior mold-part and confining an interior mold-part is shown in FIG. 6, which is a partial mold assembly 4 and 10 containing a molded toroidal framework of toroidal elements 2 and 3 in the shaping cavity.

The fifth step of the method is to remove the exterior mold-parts 4 and 7 if they do not have to be dissociated to relieve trapping of exterior surface features of the object.

The sixth step of the method is to remove any other mold-parts that are not confined by the object molded or other mold-parts, or trapped by the surface features of the object molded. In this respect it is to be noted that some of the interior mold-parts may be removable without dissociation.

In the case of the framework of toroidal elements 2 and 3 shown in FIG. 1 the mold part 10 is confined by the object to be molded, the framework 2 and 3. The framework 2 and 3 must therefore be freed from the mold part 10.

The seventh step of the method is the separation of the object from the mold by the dissociation of the remaining mold-parts by one or more of the ways in which the mold material may be dissociated, such as chemically dissociation, vaporizing, liquidization, pulverizing, dissolving, thermolysis, or other reduction from the solid state that will allow for removal of the mold material from the object after the formation of the object. Different mold-parts may be dissociated in different ways, depending on the shape of the object and the material molded.

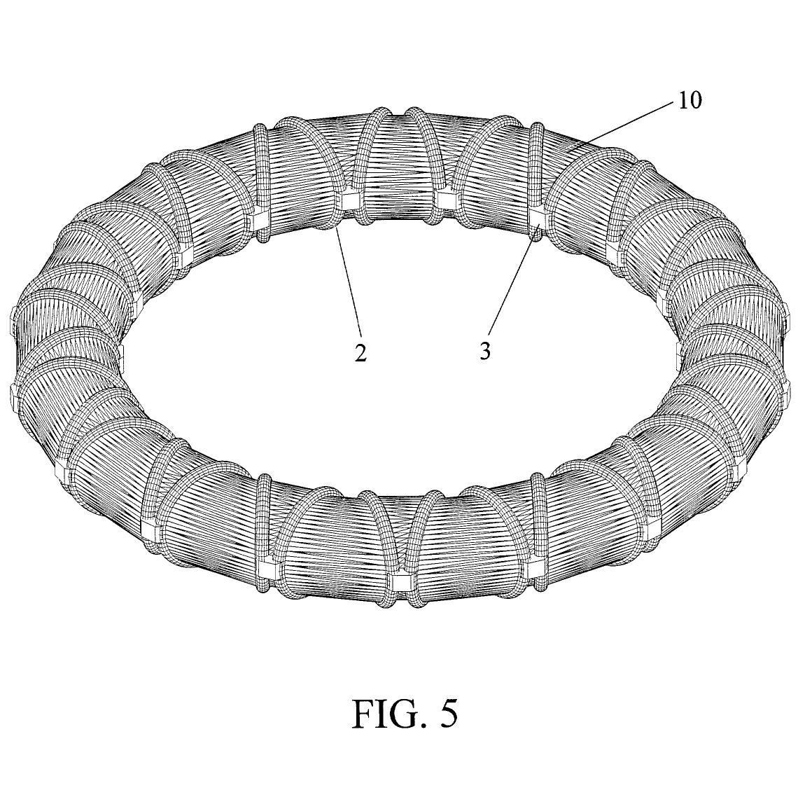

A significant example of the use of the method is the production in one piece of small toroidal frameworks of toroidal elements as shown in FIG. 1 in a metal utilizing metal injection molding. The process of metal injection molding generally includes injection into a shaping cavity of a fluent stock which is comprised of powdered metal and a resinous material serving as a carrier for the powdered metal. The molded piece is then heated to sintering temperatures for the metal, usually in an atmospherically controlled oven, and is reduced to its metal constituents by the removal of the resinous material from the molded piece, usually with dissociation. As the resin is removed, usually in a gaseous state, the metal powder is fused by sintering, thus rendering the object in the metal alone. A toroidal framework of toroidal elements 2, as shown in FIG. 1, may thus be produced in a metal in one piece, including the connectors 3, by metal injection molding by using interior 10 and exterior 4 and 7 mold-parts. However, because a toroidal framework of toroidal elements 2 and 3 is a closed shape which would confine the interior mold-part 10, as shown in FIG. 5, it is necessary to remove the interior mold-part 10 in order to completely free the object from the mold. This is accomplished using the present invention by constructing the interior mold-parts 10 with the same or similar resinous material which is dissociable in a way similar to that of the material which is the carrier for the powdered metal. After the introduction of the fluent stock into the shaping cavity and its solidification to the desired form of the toroidal framework, the exterior mold-parts 4 and 7 are removed. With the exterior mold-parts 4 and 7 removed, the toroidal framework of toroidal elements 2 and 3 molded in the powdered metal and dissociable carrier mixture is heated to sintering temperatures for the powdered metal in an atmospherically controlled oven, dissociating the interior mold-part 10 to a vapor state as well as the resinous carrier for the powdered metal, and reducing the toroidal framework of toroidal elements 2 and 3 to its metal constituents with the confined interior mold-part 10 removed. Such an interior mold-part may be a solid rendering in the dissociable material 10, or may be hollow with one or more inner voids 13, either of which may be produced in sections 10a and 10b to meet the requirements for molding the toroidal framework of toroidal elements.

Taking again a toroidal framework of toroidal elements 2 and 3, as shown in FIG. 1, as an example of a closed shape the present invention may also be applied to mold such a framework in a polymer such as nylon. In such an application of the method, the interior mold-part 10 may be made of a material that is soluble in a solvent to which the polymer is insoluble, so that the interior mold-part 10 can be dissociated by dissolution. The present method for polymers may also be carried out by using a material for an interior mold-part 10 that can be dissociated by chemical action to which the polymer is impervious, or dissociated by pulverization by effects of ultrasound, like glass or ceramic materials. Indeed, the framework itself may be molded in glass with the interior mold-parts made of a material able to withstand the temperature of molten glass but subject to acidic dissociation. The framework material to be molded with this method may also be a ceramic formed by a process similar to metal injection molding.

While the invention has been disclosed in connection with the example of the toroidal framework of toroidal elements, it will be understood that there is no intention to limit the method which is the invention to the particular embodiment shown, but it is intended to cover the general application of the method and the various alternative and equivalent constructions included within the spirit and scope of the appended claims.

What I claim as my invention is:

1. A method for molding an object which has a closed shape which comprises:
(a) first, constructing a mold for the object in two or more mold-parts, at least one interior mold-part and at least one exterior mold-part, wherein:
(1) said at least one interior mold-part and said at least one exterior mold-part have surfaces which bear the impression of the object to be molded;
(2) said at least one interior mold-part and said at least one exterior mold-part together form in a shaping cavity in the shape of the object to be molded; and
(3) an interior mold-part forms all or part of one or more of the interior surfaces of the object to be molded, and an exterior mold-part forms all or part of one or more of the exterior surfaces of the object to be molded;
(b) second, assembling the mold so that the interior mold-parts are enclosed in the corresponding exterior mold-parts to form a shaping cavity in the shape of the object with ports for the introduction of the fluent stock to be molded into the object;
(c) third, introducing the fluent stock to be molded into the object by pouring or by injection;
(d) fourth, curing the fluent stock so that it will maintain the shape into which it was molded with the mold removed;
(e) fifth, separating from the molded object the exterior mold-parts that are not trapped by the surface features of the molded object;
(f) sixth, separating from the molded object any interior mold parts that are not confined by the object molded or confined by trapped exterior mold-parts;
(g) seventh, dissociating the remaining mold-parts which have not been separated from the molded object.

2. The method as recited in claim 1, wherein the step of constructing the mold includes an interior mold-part further comprised of two or more sub-parts.

3. The method as recited in claim 1, wherein the step of constructing the mold includes an exterior mold-part further comprised of two or more sub-parts.

4. The method as recited in claim 1, wherein the step of constructing the mold includes at least one interior mold-part composed of a material that differs from the material used to mold the object, so that the effect of an environment to which both materials are subjected can be regulated to be different on each of the materials.

5. The method as recited in claim 1, wherein the interior mold-part is composed of a material which is in a solid state during the molding process and is dissociable after the curing of the fluent stock from which the object is molded.

6. The method as recited in claim 1, wherein the step of curing may be passive or active.

7. The method as recited in claim 1, wherein the first through fourth steps are metal injection molding.

8. The method as recited in claim 6, wherein the interior mold-parts are composed of the same resinous material as the carrier for the powdered metal.

9. The method as recited in claim 6, wherein the interior mold-parts are composed of a resinous material which is dissociable in the same way as that of the resinous material which is the carrier for the powdered metal.

10. The method as recited in claim 1, wherein the object is molded in a polymer.

11. The method as recited in claim 9, wherein the step of dissociation is carried out with interior mold-parts which are composed of a material that is soluble in a solvent in which the polymer of which the molded object is composed is insoluble, so that the interior mold-parts are dissociated by dissolution without having any effect on the molded object.

12. The method as recited in claim 1, wherein the step of dissociation is carried out by a chemical reaction to which the material in which the object is molded is impervious.

13. The method as recited in claim 1, wherein the step of dissociation is carried out with pulverization by ultrasound to which the material of the molded object is impervious.

14. The method as recited in claim 1, wherein the during the step of dissociating the remaining mold-parts the molded object has one or more openings between the interior and exterior of the closed shape of sufficient size to allow the atoms, molecules, or particles of the dissociated material of the mold to pass through.

15. The method as recited in claim 1, wherein the step of dissociating the remaining mold-parts includes one or more of the processes of chemical dissociation, vaporizing, liquidization, pulverizing, dissolving, or thermolyzing the mold material.

16. The method as recited in claim 1, wherein the step of dissociating the remaining mold-parts includes reduction from the solid state to particles of the material of which said mold-parts are composed that will allow for removal of such material from molded object after the formation of said molded object.

17. The method as recited in claim 1, wherein the molded object is a toroidal framework of toroidal elements.

18. The method as recited in claim 17, wherein the toroidal framework of toroidal elements is molded in one piece.

19. A method for molding an a toroidal framework of toroidal elements having a closed shape in one piece which comprises:
(a) first, constructing a mold for the framework in two or more mold-parts, at least one interior mold-part and at least one exterior mold-part, wherein:
(1) said at least one interior mold-part and said at least one exterior mold-part have surfaces which bear the impression of the framework to be molded;
(2) said at least one interior mold-part and said at least one exterior mold-part together form in a shaping cavity in the shape of the framework to be molded;
(3) an interior mold-part forms all or part of one or more of the interior surfaces of the framework to be molded, and an exterior mold-part forms all or part of one or more of the exterior surfaces of the framework to be molded; and
(4) each of said at least one interior mold-part is comprised of a material that differs from the material used to mold the framework, so that the effect of an environment to which both materials are subjected can be regulated to be different on each of the materials;
(b) second, assembling the mold so that the interior mold-parts are enclosed in the corresponding exterior mold-parts to form a shaping cavity in the shape of the framework with ports for the introduction of the fluent stock to be molded into the framework;
(c) third, introducing the fluent stock to be molded by pouring or by injection;
(d) fourth, curing the fluent stock so that it will maintain the shape into which it was molded with the mold removed;
(e) fifth, separating from the framework molded the exterior mold-parts that are not trapped by the surface features of the framework molded;
(f) sixth, separating from the framework molded any interior mold parts that are not confined by the framework molded or confined by trapped exterior mold-parts;
(g) seventh, dissociating the remaining mold-parts which have not been separated from the framework molded.

20. A method for molding an object which has a closed shape with moldable features on the interior surface thereof, which comprises: constructing a mold for the object in two or more mold-parts, one or more interior mold-part and one or more exterior mold-part; wherein at least one interior mold-part is confined by the molded object, is composed of a material which is in a solid state during the introduction of the fluent stock from which the object is molded and is dissociable after the curing of such fluent stock; and dissociating said at least one interior mold-part which can not be separated from the molded object as a result of its confinement.
